(19) United States
(12) Patent Application Publication
(10) Pub. No.: US 2007/0132673 A1
(43) Pub. Date: Jun. 14, 2007

(54) Display device

(76) Inventors: Yushi Jinno, Gifu-shi (JP); Kyoji Ikeda, Yoro-gun (JP); Kenya Uesugi, Osaka (JP)

Correspondence Address: CANTOR COLBURN, LLP, 55 GRIFFIN ROAD SOUTH, BLOOMFIELD, CT, 06002, US

(21) Appl. No.: 11/543,634

(22) Filed: Oct. 4, 2006

(30) Foreign Application Priority Data
Oct. 4, 2005 (JP) 2005-291643

(51) Int. Cl. G09G 3/30

(52) U.S. Cl. 345/76

(57) ABSTRACT

Each pixel has a display element, a pixel transistor which controls an operation of the display element, and a storage capacitor which stores charges corresponding to display data for a predetermined period. During a normal operation, a capacitor signal to be output to a capacitor line connected to each storage capacitor is AC driven in a predetermined period to improve display quality or the like. A structure to fix the capacitor signal to be output to the capacitor line to a fixed level during defect inspection of the pixel or the like is formed on a substrate simultaneously with a pixel circuit or the like. With this structure, the inspection precision can be improved when the defect inspection of each pixel is to be detected from capacitance value data or the like in each pixel. It is also possible to allow setting of the fixed level in the inspection to an arbitrary inspection voltage suitable for the inspection.

### CROSS-REFERENCE TO RELATED APPLICATIONS

The entire disclosure of Japanese Patent Application No. 2005-291643 including specification, claims, drawings, and abstract is incorporated herein by reference.

### BACKGROUND OF THE INVENTION

1. Field of the Invention

The present invention relates to inspection of a display device which uses, for example, an organic electroluminescence (hereinafter referred to as “EL”) element as a display element in each pixel.

2. Description of the Related Art

Display devices which use an organic EL element, which is a current-driven light emitting element, as a display element in each pixel are known, with active matrix display devices in which a transistor (thin film transistor or “TFT”) is provided in each pixel for individually driving, for each pixel, the organic EL element provided in each pixel being a particular focus of development.

In an active matrix display device, a gate line GL is provided along a horizontal scan direction (row direction), a data line DL and a power supply line PL are provided along a vertical scan direction (column direction), and pixels are defined by these lines. As the equivalent circuit of each pixel, a circuit shown in FIG. 13 is known in which each pixel comprises a selection transistor Ts which is an n-channel TFT, a storage capacitor Cs, an element driving transistor Td which is a p-channel TFT, and an organic EL element EL. The selection transistor Ts has a drain connected to a data Japanese Patent Laid-Open Publication Nos. Hei 11-24604 and 2003-150127 disclose art related to the present invention.

The above-described organic EL element has superior responsiveness with respect to supply and termination of supply of current, and, fundamentally, there is no tendency for persistent images to occur. However, in the display device which uses a pixel circuit as described above, there is a problem in that persistent images do occur and display quality is degraded. This is considered to be due to hysteresis of the p-channel element driving transistor. More specifically, the element driving transistor supplies a drive current from the power supply Pvdd for approximately one frame period according to the data voltage stored in the storage capacitor and supplied to the gate of the element driving transistor and then, after the next data voltage is written to the storage capacitor Cs, supplies a drive current in the next frame period according to a new data voltage. Because the element driving transistor Td supplies the same current throughout one frame period in this manner, this state is retained and the influence of the data voltage written previously remains even after the next data voltage is supplied. This phenomenon becomes even more significant when the data voltage is at an intermediate level and becomes particularly problematic when an animated image having a large variation in data voltage is to be displayed.

### SUMMARY OF THE INVENTION

The present invention advantageously reduces occurrences of persistent images.

The present invention advantageously maintains or improves inspection precision in the display region by controlling a capacitor line DL which supplies a data voltage to pixels positioned along the vertical scan direction, a gate connected to a gate line GL for selecting pixels positioned along the horizontal scan direction, and a source connected to a gate of the element driving transistor Td.

The element driving transistor Td has a source connected to the power supply line PL and a drain connected to an anode of the organic EL element EL. A cathode of the organic EL element EL is formed common to the pixels and is connected to a cathode power supply CV. One electrode of a storage capacitor Cs is connected between the gate of the element driving transistor Td and the source of the selection transistor Ts. The other electrode of the storage capacitor Cs is connected to a power supply of a constant voltage such as, for example, ground.

In this circuit, when the gate line GL is set to the H level, the selection transistor Ts is switched on, a data voltage on the data line DL is supplied via the selection transistor Ts to the gate of the element driving transistor Td, and a voltage corresponding to the data voltage is stored in the storage capacitor Cs. In this manner, the element driving transistor Td allows a drive current corresponding to the gate voltage (the voltage stored in the storage capacitor Cs) of the element driving transistor Td to flow through the element driving transistor Td, and, even when the gate line GL is set to an L level, the element driving transistor Td supplies the drive current from the power supply line PL connected to a drive power supply PVDD to the organic EL element EL according to the voltage stored in the storage capacitor Cs, and, as a result, the organic EL element EL emits light at an intensity corresponding to the drive current. line which is alternate-current (AC) driven.

According to one aspect of the present invention, there is provided a display device comprising a display region having a plurality of pixels arranged in a matrix form and a driver circuit which drives the plurality of pixels in the display region, wherein, in the display region, each of the plurality of pixels comprises a display element, a pixel transistor which controls the display element according to display data, and a storage capacitor which stores the display data for a predetermined period, and the storage capacitor comprises a first electrode and a second electrode, the first electrode being connected between the pixel transistor and the display element and the second electrode being connected to a capacitor line. The driver circuit comprises at least a vertical direction driver and a capacitor signal fixing section. The vertical direction driver comprises a capacitor signal generator which outputs a predetermined alternate current signal to the capacitor line as a capacitor signal and the capacitor signal fixing section selectively fixes the capacitor signal which is output from the capacitor signal generator to a direct current level.

According to another aspect of the present invention, there is provided a display device comprising a display region having a plurality of pixels arranged in a matrix form and a driver circuit which drives the plurality of pixels in the display region, wherein, in the display region, each of the plurality of pixels comprises a display element, a pixel transistor which controls the display element according to display data, and a storage capacitor which stores the display data for a predetermined period, the storage capacitor comprises a first electrode and a second electrode, the first electrode being connected between the pixel transistor and the display element and the second electrode being connected to a capacitor line, a selection line for selecting a pixel transistor of a corresponding pixel and a capacitor line for controlling a potential on the second electrode of the storage capacitor are formed extending along a horizontal scan direction of the display region, the driver circuit comprises at least a vertical direction driver and a capacitor signal fixing section, the vertical direction driver generates, based on a vertical start signal indicating a start timing of a vertical scan period, a selection signal which is sequentially output to the selection line for selecting the pixel transistor of a corresponding row and generates a capacitor signal in which a first voltage level period and a second voltage level period are set in a horizontal scan period based on the vertical start signal and which is sequentially output to the capacitor line, and the capacitor signal fixing section selectively fixes the capacitor signal which is output from the vertical direction driver to a direct current level.

According to another aspect of the present invention, it is preferable that, in the display device, the capacitor signal generator comprises a logic circuit which outputs the capacitor signal to the capacitor line, and a fix control signal of a predetermined level from the capacitor signal fixing section is supplied to an input terminal of the logic circuit and an output level of the capacitor signal from the logic circuit is fixed according to the fix control signal.

According to another aspect of the present invention, it is preferable that the display device further comprises a level setting section which sets the voltage level of the capacitor signal which is output from the capacitor signal generator.

According to another aspect of the present invention, it is preferable that, in the display device, when the level setting section detects that a fix control signal is being output from the capacitor signal fixing section, the level setting section sets a level of an output section power supply voltage which determines a voltage value of the capacitor signal at a capacitor signal outputting section of the capacitor signal generator.

According to another aspect of the present invention, it is preferable that, in the display device, the level setting section comprises a level setting terminal and the voltage level of the capacitor signal can be set according to a setting power supply connected to the level setting terminal.

According to another aspect of the present invention, it is preferable that, in the display device, the capacitor signal fixing section comprises a fix control terminal and controls fixing of the capacitor signal to the direct current level according to a power supply voltage connected to the fix control terminal.

According to another aspect of the present invention, it is preferable that, in the display device, the capacitor signal fixing section can fix a level of the capacitor signal during an operation inspection mode in the display region.

As described, according to the present invention, a capacitor signal which is output to a capacitor line connected to a storage capacitor provided in each pixel and which is AC driven can be selectively fixed. In other words, the capacitor signal can be fixed as necessary such as, for example, when a defect inspection is to be executed for the display panel on which the pixels are formed before the product is shipped from the factory. During the inspection, a change of a very small capacitance value or the like of each pixel is inspected. Therefore, if the level of the capacitor signal significantly changes during inspection, the change in the capacitance value of each pixel to be measured would be large, and, thus, small changes in capacitance cannot be precisely measured. With the present invention, however, because the change in the capacitor signal can be stopped as necessary, it is possible to improve both the display quality during normal display and the precision of defect inspection.

In addition, by allowing setting of the voltage level to be output to the capacitor line to a predetermined level by the capacitor signal fixing section, it is possible to set the measurement condition to a wide range during the defect inspection and the display devices can be inspected with a higher precision. Because the S/N ratio of the detection signal obtained in the defect inspection can be improved, the measurement time can be reduced and the processing capability can be improved.

Because the capacitor signal can be AC driven during a normal display operation or the like, it is possible to control the operation of the display element to be switched off by forcefully controlling the pixel transistor of a corresponding pixel to be switched off, to inhibit occurrence of persistent images and prevent burnt images by AC driving the display element.

### BRIEF DESCRIPTION OF THE DRAWINGS

Preferred embodiments of the present invention will be described in detail by reference to the drawings, wherein:

FIG. 1 is an explanatory diagram schematically showing an equivalent circuit of a light emitting display device according to a preferred embodiment of the present invention;

FIG. 2 is a diagram exemplifying a circuit structure of a V driver according to a first preferred embodiment of the present invention;

FIG. 3 is a diagram enlarging a portion of a structure shown in FIG. 2;

FIG. 4 is a timing chart showing an operation of the circuit structure of FIG. 2;

FIG. 5 is a diagram exemplifying a circuit structure of a V driver according to a second preferred embodiment of the present invention;

FIG. 6 is a diagram exemplifying a circuit structure of a V driver according to a third preferred embodiment of the present invention;

FIG. 7 is a timing chart showing an operation of a circuit structure of FIG. 6;

FIG. 8 is a diagram for explaining the structure of a logic circuit in which the circuit structure of FIG. 6 is generalized;

FIG. 9 is a timing chart showing an operation of the circuit structure of FIG. 8;

FIG. 10 is an explanatory diagram schematically showing an equivalent circuit of a liquid crystal display device according to a preferred embodiment of the present invention;

FIG. 11 is an explanatory diagram schematically showing an equivalent circuit of a liquid crystal display device according to a preferred embodiment, different from that shown in FIG. 10;

FIG. 12 is a diagram showing a drive waveform in the circuit structure of FIG. 10 during a normal display operation; and

FIG. 13 is a diagram showing an equivalent circuit of a pixel of a light emitting display device of related art.

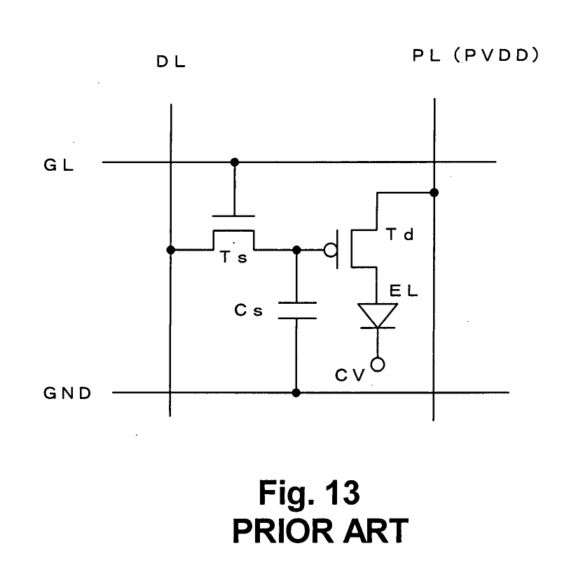

### DESCRIPTION OF THE PREFERRED EMBODIMENTS

Preferred embodiments of the present invention will now be described referring to the drawings.

### First Preferred Embodiment

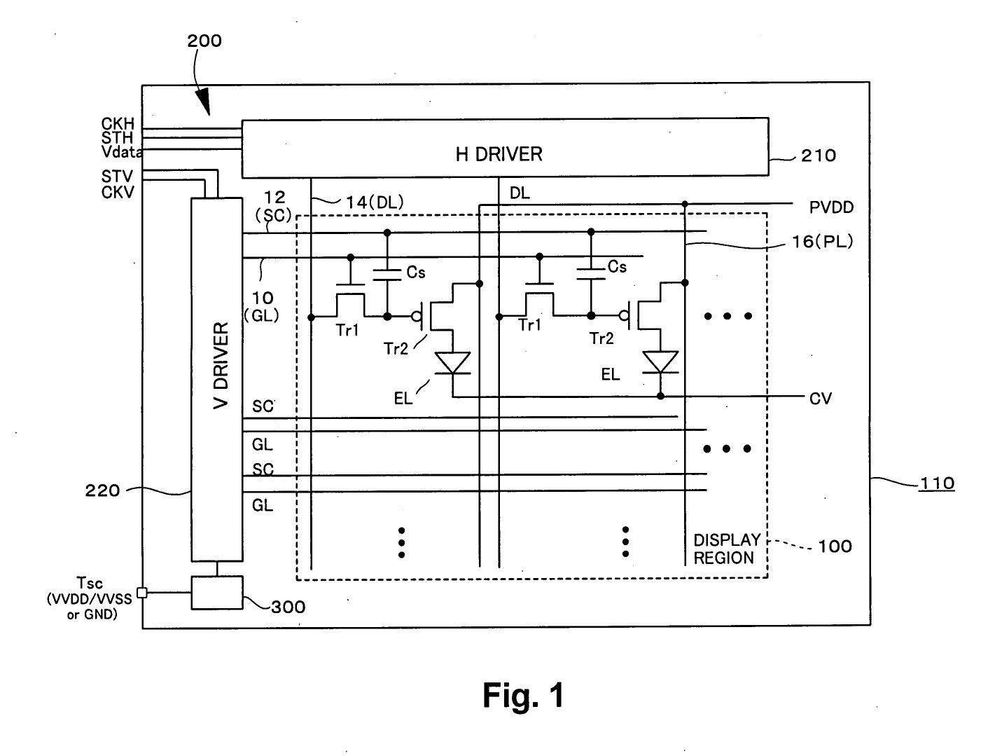

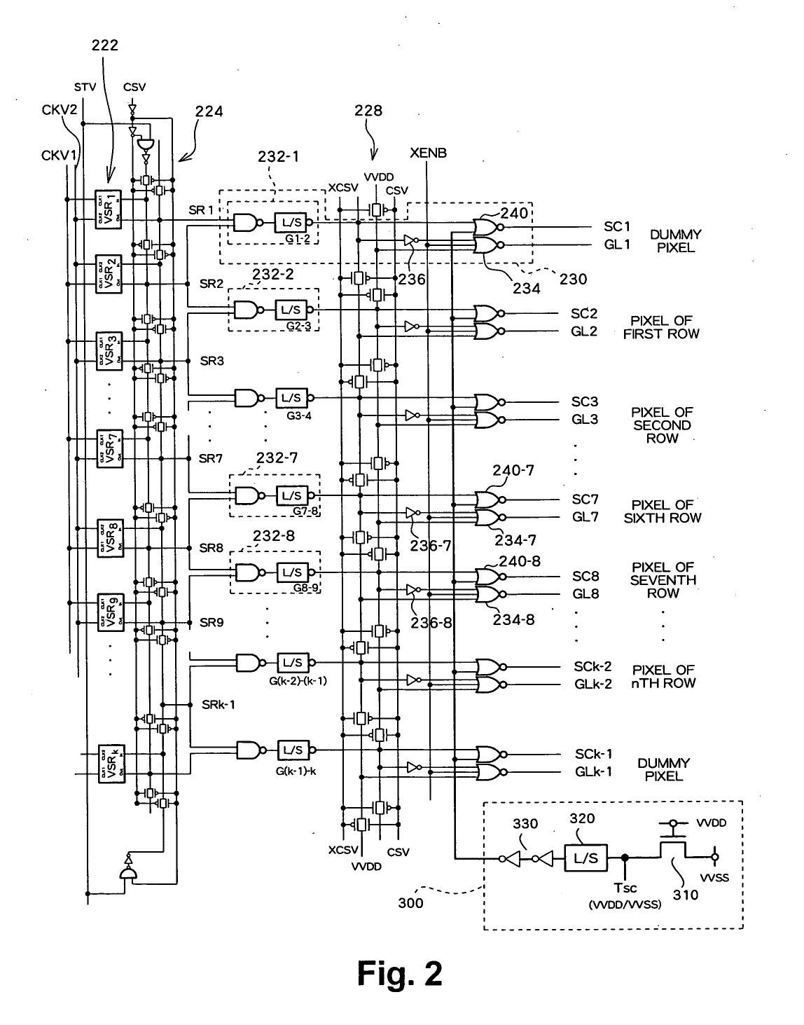

In this embodiment, the display is an active matrix EL display wherein a plurality of pixels are placed on a panel substrate 110 such as glass in a matrix form. FIG. 1 is a diagram showing an equivalent circuit structure of the active matrix display according to the present embodiment. FIG. 2 shows a more specific circuit structure of the V driver and the capacitor fix controller of FIG. 1. A gate line (selection line) 10 (GL) to which a selection signal is sequentially output is provided along a horizontal scan direction (row direction) of the matrix on the panel substrate 110 and a data line 14 (DL) to which a data signal is output and a power supply line (PL) 16 for supplying an operation power supply (PVDD) to an organic EL element which is an element to be driven are provided along a vertical scan direction (column direction).

Each pixel is provided around a region defined by these lines and comprises, as circuit elements, an organic EL element which is the element to be driven, a selection transistor Tr1 which is an n-channel TFT and an element driving transistor Tr2 which is a p-channel TFT as pixel transistors, and a storage capacitor Cs.

The selection transistor Tr1 has a drain connected to a data line 14 for supplying a data voltage to the pixels positioned along the vertical scan direction, a gate connected to a gate line 10 for selecting pixels on one horizontal scan line, and a source connected to a gate of the element driving transistor Tr2.

The element driving transistor Tr2 has a source connected to a power supply line 16 and a drain connected to an anode of the organic EL element EL. A cathode of the organic EL element EL is formed common to the pixels and is connected to a cathode power supply CV.

A first electrode of the storage capacitor Cs is connected to the gate of the element driving transistor Tr2 and to the source of the selection transistor Tr1, and a second electrode of the storage capacitor Cs is connected to a capacitor line 12 (SC). The capacitor line 12 is formed extending parallel to the selection line 10 and along the row direction and a capacitor signal having a voltage which periodically changes is supplied to the capacitor line 12 in order to improve persistent images in the pixels, as will be described.

In both the selection transistor Tr1 and the element driving transistor Tr2, a semiconductor material is used as an active layer. For example, crystalline silicon such as, for example, polycrystalline silicon obtained by polycrystallization through laser annealing is used in the active layer. In addition, the selection transistor Tr1 and the element driving transistor Tr2 may be an n-channel thin film transistor (TFT) or a p-channel thin film transistor in which an n-conductive impurity or a p-conductive impurity is doped as impurity, respectively. The active layer of the TFT is not limited to the polycrystalline silicon and, alternatively, it is also possible to use amorphous silicon.

When a TFT in which crystalline silicon is used in the active layer as described above is employed as the transistor of the pixel circuit, the crystalline silicon TFT can be used not only for the pixel circuit, but also as circuit elements of a peripheral driver circuit for sequentially selecting and controlling the pixels. Therefore, in the present embodiment, a crystalline silicon TFT similar to that in the pixel circuit is formed outside a display portion 100 on the panel substrate 110 on which the display portion 100 is formed, simultaneously with the formation of the transistors for the pixel circuit, so that a peripheral driver circuit 200 is built in. In the display portion 100, a plurality of pixels each having the structure as described above are placed in a matrix form.

The driver 200 outputs various control signals for driving the pixels in the display portion 100. More specifically, the driver 200 comprises an H driver (horizontal direction driver circuit) 210 and a V driver (vertical direction driver circuit) 220. The H driver 210 outputs corresponding data signals to a plurality of data lines 14 extending along the column direction of the matrix.

The V driver 220 comprises a selection signal generator (selection signal outputting section) which generates a selection signal for causing the selection transistor Tr1 to be switched on every horizontal scan (1H) period and sequentially outputs the selection signal to a plurality of selection lines 10 extending along the row direction of the matrix and a capacitor signal generator (capacitor signal outputting section) which generates and outputs a storage capacitor signal which causes the potential of the capacitor line 12 to be periodically changed.

A capacitor signal fixing section 300 for selectively fixing the storage capacitor signal from the capacitor signal outputting section is provided in the display according to the present embodiment. The capacitor signal fixing section 300 does not limit the output of the capacitor signal during a normal display of the display (allows output of an AC capacitor signal) and fixes the voltage level of the capacitor signal to convert the signal into a DC signal when a defect inspection of the display panel is performed during, for example, shipping from the factory.

In the present embodiment, at least the signal outputting section of the capacitor signal generator is formed using a logic circuit 240 (here, a NOR circuit) provided for each row, as will be described later. In other words, at least the signal outputting section of the capacitor signal generator has a digital signal processing structure. Because of this, the capacitor signal fixing section 300 only needs to have at least a selector terminal Tsc (capacitor fix controlling terminal) which can be connected to a predetermined external power supply. By outputting a capacitor fix control signal (fix control signal) of a predetermined level form the selector terminal Tsc to the logic circuit 240 of the capacitor signal generator, it is possible to fix the output level of the logic circuit 240 regardless of the signal supplied to the other input terminal(s) of the logic circuit 240. In particular, in the configuration of the present embodiment, by connecting and supplying, from the outside, a power supply VVDD as a fix control power supply to the selector terminal Tsc, it is possible to fix one of the inputs of the capacitor signal outputting section (NOR circuit 240) to the H level, and the output of the NOR circuit 240 is automatically fixed to the L level in this configuration.

In the present embodiment, as shown in FIG. 2, the capacitor signal fixing section 300 comprises a switching element 310 in addition to the selector terminal Tsc. The switching element 310 can be formed using a thin film transistor having a same structure as that of the thin film transistor of the pixel circuit or of the peripheral driver 200. More specifically, the switching element 310 can be formed using, for example, an n-channel TFT. When an n-channel TFT is used, a gate is connected to a high voltage power supply (VVDD) and a drain (or a source) is connected to GND (grounded). The drain or the source may alternatively be connected to a low voltage power supply VVSS. The source (or the drain) is connected to the selector terminal Tsc and to the capacitor signal outputting section via a level shifter 320 and a buffer 330.

The n-channel TFT 310 is always in the ON state. However, in a predetermined inspection mode such as inspection for defects in the pixel circuit, the VVDD power supply is selectively connected to the selector terminal Tsc so that an H level signal corresponding to the VVDD of the selector terminal Tsc is supplied to the capacitor signal outputting section. On the other hand, during inspections other than the predetermined defect inspection mode and when the device is shipped from the factory after the inspection is completed (a normal operation mode in which the device is used by the user), the selector terminal Tsc is connected to, for example, the low voltage power supply VVSS or to the GND, or is set to “floating”. Because the TFT 310 is always ON as described above, when the selector terminal Tsc is set to “floating”, an L level signal corresponding to the voltage of the power supply (GND or VVSS) connected to the drain (or source) of the TFT 310 is supplied via the TFT 310 to the capacitor signal generator (outputting section). In addition, from the viewpoint of reducing the power consumption at the TFT 310 which is always ON, it is preferable to use GND as the L level power supply to be connected to the selector terminal Tsc during the normal operation or during other inspections if the drain (or the source) of the TFT 310 is connected to the GND, and use VVSS as the L level power supply connected to the selection terminal Tsc if the drain (or the source) is connected to the VVSS.

Next, an operation method and a driving method in the normal operation mode in the circuit structure of FIG. 1 will be described. In each pixel circuit, when the selection signal which is output to the selection line 10 is set to an H level, the selection transistor Tr1 is switched ON and a data voltage corresponding to a data signal on the data line 14 is applied to the gate of the element driving transistor Tr2 and the first electrode of the storage capacitor Cs via the drain and the source of the selection transistor Tr1.

The storage capacitor Cs stores a voltage corresponding to a potential difference between the data voltage applied to the first electrode and a capacitor control voltage supplied from the capacitor line 12 connected to the second electrode. In the present embodiment, during the writing process of the data voltage, the voltage of the capacitor signal on the capacitor line 12 is maintained at a first voltage level Vsc1 which is a low constant voltage such as, for example, ground level (0V), and the data voltage applied to the first electrode of the storage capacitor Cs is stored as the gate voltage of the element driving transistor Tr2. More specifically, the data voltage is stored in the storage capacitor Cs as a potential difference with respect to the first voltage level applied to the capacitor line 12. Because the element driving transistor Tr2 is a p-channel transistor, the data voltage determines the drive current to flow through the element driving transistor Tr2 by how low the data voltage is with respect to the power supply voltage PVDD. When the value by which the power supply voltage exceeds the data voltage increases, the drive current becomes larger, and, thus, the light emission brightness of the organic EL element increases.

Even when the selection signal on the selection line 10 is set to an L level and the selection transistor Tr1 is switched OFF, the storage capacitor Cs continues to store the voltage corresponding to the data signal. Therefore, the element driving transistor Tr2 continues to supply the drive current to the organic EL element EL and the organic EL element EL continues to emit light according to the data voltage.

In the present embodiment, however, the organic EL element does not continue to emit light according to a previous data signal until a corresponding pixel is selected at the next vertical scan (frame) period and a new data signal is written. Rather, the element driving transistor Tr2 is controlled to be switched off and the organic EL element is extinguished (switched off) during a period until the next frame period after the organic EL element is allowed to emit light according to the data voltage for a predetermined period.

More specifically, the capacitor signal to be output to the capacitor line 12 is increased from the first voltage level Vsc1 to a second voltage level Vsc2 which is sufficiently high for switching the element driving transistor Tr2 off (for example, 10V) after a predetermined period has elapsed. As described above, the first electrode of the storage capacitor Cs is connected to the gate of the element driving transistor Tr2 and the source of the selection transistor Tr1. When the potential of the second electrode of the storage capacitor Cs is increased to the second voltage Vsc2 by the capacitor line (capacitor control line) SC, the potential on the first electrode of the storage capacitor Cs is increased according to the amount of increase ΔV (Vsc2−Vsc1). The power supply voltage PVDD is set at, for example, 8V. Therefore, when the capacitor signal is increased to the second potential level Vsc2, the gate voltage Vg of the element driving transistor Tr2 becomes higher than the power supply voltage PVDD which is the source potential (even when the gate voltage Vg is lower than the source potential, the potential difference would be smaller than the operation threshold value Vthp of the transistor Tr2) and the element driving transistor Tr2 is switched off.

Because of this configuration, if one of the pixels is considered, the element driving transistor Tr2 is controlled to be switched off before the pixel of interest is again selected at the next frame period and the organic EL element emits light according to a new data voltage, and, thus, the organic EL element is forcefully extinguished. In this manner, the element driving transistor Tr2 is controlled to be temporarily switched off and the organic EL element is extinguished, and, as a result, the persistent images can be improved.

In addition, in the present embodiment, even when carriers (holes) are trapped in the gate insulating film of the element driving transistor Tr2, because the gate voltage Vg of the element driving transistor Tr2 is increased according to the amount of increase ΔV of the first electrode of the storage capacitor Cs before the display of the next frame period is started, the trapped carriers can be extracted as a tunneling current to the source which is at a lower potential than the gate. Therefore, the electrical characteristic of the element driving transistor Tr2 is initialized and the supply of drive current to the organic EL element can be reliably and completely stopped.

In the present embodiment, a structure for switching the capacitor voltage (capacitor control voltage) is built in (integrated) on the panel substrate. Although the voltage on the capacitor line 12 can be controlled using an external IC, when the voltage on the capacitor line 12 is controlled using an external IC, because the number of panel connection terminals for receiving signals from the external circuits is limited, it is preferable that all capacitor lines 12 be controlled at once and the potentials of all of the capacitor control signals are increased in the blanking period at once. However, provision of the structure for switching the capacitor control voltage in the built-in (integrated) driver has an advantage that the control for each individual row becomes easier, and, thus, the period of the increased voltage can be arbitrarily set. In addition, by controlling the potential of the capacitor line 12 for each row, it is possible to control the element driving transistor Tr2 to be switched off for an equal period with respect to any pixel in any row position on the screen. When potentials of all of the capacitor lines 12 are to be increased at once during a blanking period by an external IC, regarding a pixel which is selected immediately before the vertical blanking period, a high voltage is applied from the capacitor line to the storage capacitor immediately after a data signal is written to the storage capacitor, and, thus, the leakage current of the selection transistor is increased and the data which should have been displayed may be lost, resulting in a degraded display quality. With the built-in switching structure, this degradation of the display quality can be prevented.

In addition, when the voltage of the capacitor line 12 is controlled between the first and second voltage levels by an external IC, the actual voltage reaching the gate of the element driving transistor is reduced due to influences of the line resistance and the parasitic capacitance or the like with respect to the line, and, thus, a high driving capability is required for the external IC such as an increase in the amplitude of the output voltage of the external IC, or the power consumption in the external IC is increased. If a circuit which generates a capacitor signal to be output to the capacitor line 12 as described is provided in a driver built into the panel, because the amplitude of the control signal does not significantly differ from that of the selection signal or the like, the capacitor signal of a sufficient amplitude can be generated with a simple structure while minimizing the increase in the power consumption of the driver, by the capacitor signal generator circuit and the selection signal generator circuit sharing the power supply, for example. In addition, because the capacitor signal generated in a built-in driver is output to the capacitor line, the target potential to be reached of the gate voltage Vg of the element driving transistor when the second voltage level Vsc2 is output is higher than that in the control using an external IC by, for example, approximately 10%-20% or more, and the target reaching time can be easily shortened.

By building a structure for switching the capacitor control voltage into the panel as described, it is possible to more reliably improve the display quality. In general, however, when a driver circuit is built in, the circuit can only be operated in a predetermined manner, that is, a manner similar to the normal usage, even during the defect inspection of the pixel circuit prior to shipping of the panel from the factory. In other words, in the structure of the present embodiment, the level of the capacitor signal significantly changes. However, during a defect inspection of the pixel circuit, a small capacitance of the pixel circuit is measured and the defect in the storage capacitor Cs, the driver transistor, etc. is determined. If the potential on the capacitor line significantly changes during measurement, the change in the capacitance value in each pixel would be large and small changes in the capacitance cannot be measured with high precision.

In consideration of this limitation, in the present embodiment, in addition to the built-in structure for switching the capacitor voltage (capacitor control voltage), a capacitor signal fixing section 300 is built into the panel to allow fixing of the capacitor voltage level as necessary. More specifically, during a defect inspection mode of the pixel circuit or a persistent image inspection mode, a high voltage power supply such as VVDD is supplied to the control terminal Tsc, and the power supply voltage is input to the capacitor signal generator as the H level signal. With this structure, the output of the logic circuit 240 comprising the NOR circuit as shown in FIG. 2, etc. is fixed to the L level regardless of the input signal at the other terminals. Thus, the defect detection process of the pixel circuit can be executed while there is no potential change on the capacitor control line and by sequentially selecting each pixel and writing an inspection data signal. The defect detection process of the pixel circuit can be executed, for example, by writing the inspection data to the pixel and measuring a potential change on the data line or measuring a potential change on the capacitor control line.

When inspections other than the defect inspection and persistent image inspection of the pixel circuit are to be performed, for example, when an inspection which involves actual operation of the display and a voltage margin inspection is to be performed, at least the selector terminal Tsc is not fixed to the high voltage level similar to the normal operation. In other words, the level of the fix control signal to be output to the capacitor signal generator is set to a low voltage level corresponding to the low voltage power supply connected to the selector terminal Tsc and the low voltage power supply supplied via the TFT 310. Because of this, the level of the capacitor signal from the logic circuit 240 is not fixed and changes according to a signal G₍ₖ₋₁₎₋ₖ corresponding to a timing difference of register outputs supplied to the second input of the logic circuit 240. In other words, the level of the capacitor signal changes at a predetermined timing similar to the signal during the normal display operation (that is, the signal is AC driven).

A specific driver structure and an example operation of a structure in which the control circuit of the capacitor line 12 and the capacitor signal fixing section 300 according to the present embodiment are built in the panel will now be described referring to FIGS. 2-4.

First, a basic structure of the H driver 210 and the V driver 220 will be described. Here, although not specifically shown in the drawings, the H driver 210 comprises a horizontal transfer register having a plurality of stages of registers, the number of stages corresponding to the number m of columns of the display portion 100, and a sampling circuit. The horizontal transfer register sequentially transfers an H start signal STH instructing a start of one horizontal scan period to the register of the next stage (adjacent line) according to a horizontal clock CKH of a frequency corresponding to a number of pixels along the horizontal scan direction. The sampling circuit samples the display signal Vdata of, for example, each of R, G, B, and W (White) according to a selection signal corresponding to the signal STH sequentially output from the registers of the stages of the horizontal transfer register and outputs the sampled signal to the corresponding data line 14 as a data signal DL.

As shown in FIG. 2, the V driver 220 comprises a vertical transfer register 222 having k stages of registers, the number k being dependent on the number n of rows of the display portion 100 (k=n +2 in FIG. 2), a transfer control gate 224 which controls the data transfer direction of the register VSR, and a signal generator 230 (signal generation logic section) which generates the selection signal and the capacitor signal. The signal generation logic section 230 comprises a logic section which generates capacitor signals SC1-SCk to be output to the capacitor lines 12 based on a V start signal STV transferred by the register VSR and a logic section which generates selection signals GL1-GLk to be sequentially output to the selection lines 10. Similar to the control of the data transfer direction of the register VSR, a logic control gate 228 which switches between adjacent rows to be logically calculated within the signal generation logic section 230 is provided.

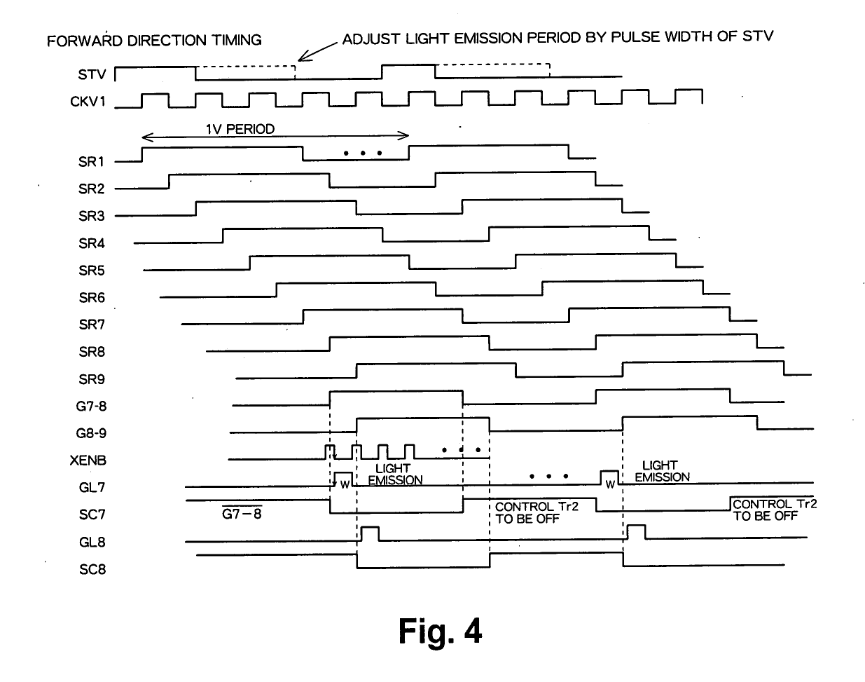

The registers VSR1-VSRk sequentially transfer a V (vertical) start signal STV which instructs start of one vertical scan period to the adjacent (adjacent row) registers VSR1-VSRk according to a vertical clock CKV having a frequency which is ½ of one horizontal scan period. The transfer control gate circuit 224 controls the transfer direction of the V start signal STV of the registers VSR1-VSRk according to a transfer direction control signal CSV. In the configuration of FIG. 2, when the signal CSV is at an H level, all of the n-channel TFTs which receive an input of the signal CSV at the gates are switched on and all of the p-channel TFTs which receive an input of the signal CSV at the gates are switched off. Thus, the inputs and outputs of the registers are controlled in such a manner that the V start signal STV is supplied to an input terminal in of the register VSR1, an output terminal out of the register VSR1 is connected to an input terminal in of the register VSR2, and an output terminal out of the register VSR2 is connected to an input terminal in of the register VSR3. Because of this, when the signal CSV is at the H level, as shown in the timing chart of FIG. 4, the data transfer direction of the vertical transfer register 222 sequentially proceeds through VSR1, VSR2, . . . VSRk. When, on the other hand, the signal CSV is at the L level, the V start signal STV is supplied to an input terminal in of the register VSRk and data corresponding to the V start signal STV is transferred in the order of VSRk, . . . VSR1.

As shown in FIG. 4, the V start signal STV is set to an H level indicating a start at the beginning of one vertical scan (one frame) period, is maintained at the H level for a predetermined period within one frame, and is switched to and maintained at the L level for the rest of the frame period. The period of H level of the V start signal STV normally has a duration of approximately one horizontal scan period, but, in the present embodiment, this period is set at a longer period such as a period corresponding to 200 horizontal scan periods. A logic circuit is provided so that the duration of the H level period determines the duration of period in which the storage control signal which is output to the capacitor lines 12 is switched on, as will be described later. In FIG. 4, the duration of the H level period is shown to be approximately 4 horizontal scan periods for the purpose of simplifying the drawing. The duration of the H level period may be set at approximately 4 horizontal scan periods as shown in FIG. 4.

Operations of each constructing element will now be described with reference to a specific case in which the CSV signal is at the H level and data is transferred in the forward direction. The V start signal STV is latched by the first register VSR1 at the rise of the vertical transfer clock CKV, and at the same time, the output SR1 of the register VSR1 is set to the H level. The H level period of the output SR1 continues until the output SR1 is changed to the L level at the timing of a first rise of the signal CKV after the V start signal supplied to the register VSR1 is set to the L level. In other words, the H level period of the register output SR1 has a duration which corresponds to the period in which the H level of the V start signal STV is maintained (pulse width).

The data latch timing of each register is deviated from all of the other registers by a half of the period of the vertical clock signal CKV. Therefore, as shown in FIG. 4, the second register VSR2 latches the output SR1 of the register VSR1 at the timing of the next fall of the signal CKV (rise of the CKV inversion signal (CKV2)) and the output SR2 is set to the H level accordingly. In this manner, each of the registers of the subsequent rows VSR3, VSRk-1, and VSRk sequentially latches the output of the register of the previous stage and transfers the output. Therefore, the outputs SR1-SRk of the registers VSR1-VSRk have, as shown in FIG. 4, waveforms in which the H level is maintained for a period corresponding to the V start signal.

At the output side of the vertical transfer register 222, a logical multiplication circuit 232 of the signal generation logic section 230 is provided. The logical multiplication circuit 232 comprises a NAND circuit which applies a NAND operation to outputs SRk−1 and SRk of registers of adjacent stages and a level shifter (L/S) with an inverting function which is provided at the output side of the NAND circuit.

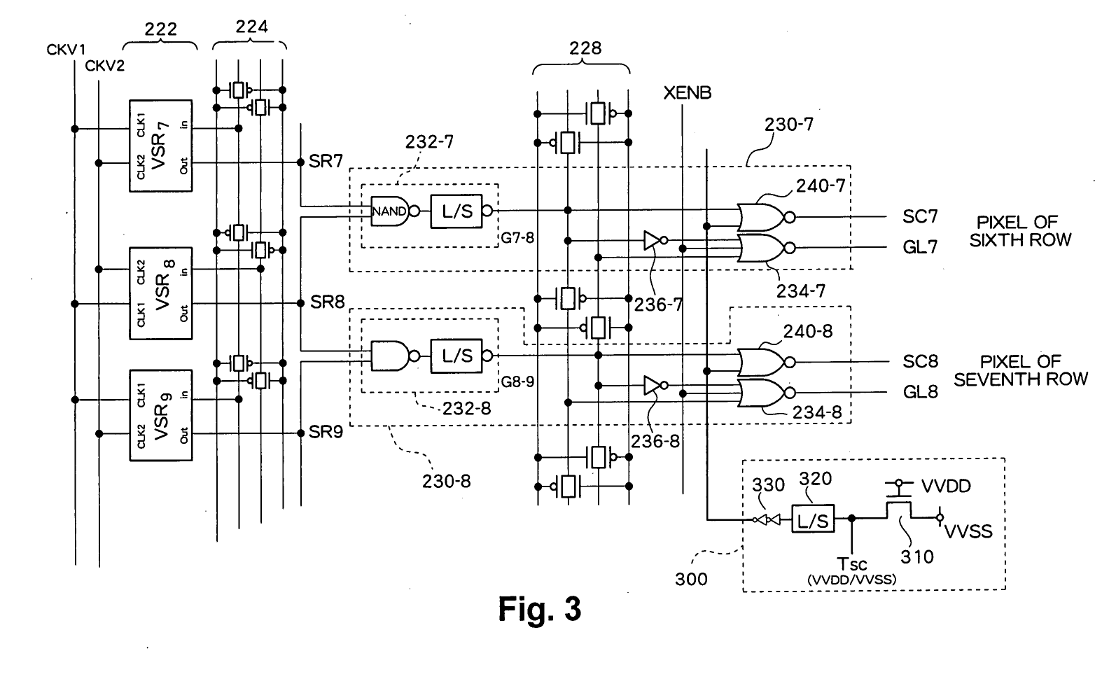

Referring to FIG. 3, which is an enlarged view of a structure which generates the selection signal GL7 and the capacitor signal SC7 to be supplied to pixels of a sixth row from the outputs SR7-SR9 of the registers VSR7-VSR9 of the middle stages shown in FIG. 2, a generation process for the selection signal GL7 and the capacitor signal SC7 based on the outputs of the registers of middle stages will be described. A NAND operation is applied to the outputs of the registers VSR7 and VSR8 in the NAND circuit of the corresponding logical multiplication circuit 232-7, the level of the NAND output is shifted and the H and L levels are inverted by the L/S with an inversion function, and the resulting signal is output. The obtained inverted output is shown as “G7-8” in FIG. 4 and a logical multiplication signal (G7-8) is obtained at the logical multiplication circuit 232-7 according to a difference in the timings of the outputs of the registers VSR7 and VSR8. A NAND operation is applied to the outputs of the registers VSR8 and VSR9 by the NAND circuit of the corresponding logical multiplication circuit 232-8, the level of the NAND output is shifted and the level is inverted by the L/S with the inversion function, and the resulting signal is output. The obtained inverted output is shown in FIG. 4 as “G8-9” and a logical multiplication signal (G8-9) is obtained at the logical multiplication circuit 232-8 according to a difference in timings of outputs of the registers VSR8 and VSR9.

The level shifter L/S with inversion function is provided so that the level of the selection signal output to the selection line 10 via a NOR circuit at the later stage becomes a level sufficient for reliably switching the selection transistor Tr1 of the corresponding row on and off. More specifically, the level shifter shifts and inverts the level so that the H level becomes −2V and the L level becomes 10V when the L level of the output of the NAND circuit of the logical multiplication circuit 232 is 0V and the H level of the output is 10V. In this manner, logical multiplication signals are output from the logical multiplication circuits 232-7 and 232-8 at the timings shown by G7-8 and G8-9 of FIG. 4.

The logical multiplication signals G7-8 and G8-9 are supplied to NOR circuits 234 and 240, respectively, via the logic control gate 228. Because the CSV signal is at the H level, the logic control gate 228 is controlled to be switched to allow supply of the output G7-8 from the logical multiplication circuit 232-7 and the output G8-9 from the logical multiplication circuit 232-8 to the NOR circuits 234-7 and 240-7 for the pixels of the sixth row, respectively.

An inverted signal of the logical multiplication output G7-8 inverted by an inverter 236-7, an eighth-logical multiplication output G8-9, and an enable signal ENB for prohibiting output of the selection signal at the switching timing of one horizontal scan (1H) period (in the circuit structure of the present embodiment, an inverted enable signal XENB as shown in FIG. 4) are supplied to the NOR circuit 234-7 for selection signal which outputs the selection signal GL7 to the pixels of the sixth row.

Therefore, a NOR calculation signal which is set to the H level (10V) only when all three input signals are at the L level is output from the seventh NOR circuit 234-7. Here, the inverted signal of the output G7-8 of the seventh logical multiplication circuit 232-7 and the output G8-9 of the eighth logical multiplication circuit 232-8 are simultaneously at the L level in FIG. 4 for a duration of a half period (1H period) of the signal CKV from the time when the output G7-8 is set to the H level until the output G8-9 is next set to the H level, and the period of the 1H of the XENB signal other than the first and last period. Therefore, the selection signal GL7 of H level is output from the NOR circuit 234-7 as shown in FIG. 4 as GL7 from the timing when the XENB signal is set to the L level to the rise to the H level. The XENB signal and the ENB signal are supplied with an amplitude of, for example, 0V and 3V from the external driver IC and are shifted by, for example, the level shifter L/S to signals of amplitudes of −2V and 10V before the signal is supplied to the NOR circuit 234.

The seventh NOR circuit 240-7 which outputs the capacitor signal receives, as inputs, an output from the capacitor signal fixing section 300 which is common to all rows and the output G7-8 of the logical multiplication circuit 232-7. As described above, in the defect inspection mode, the VVDD power supply is supplied from the external IC for defect inspection to the selector terminal Tsc of the capacitor signal fixing section 300 and the output of the capacitor signal fixing section 300 is fixed to the H level.

Because of this, the capacitor signal SC7 which is output from the NOR circuit 240-7 is fixed to the L level and the potential on the second electrodes of the storage capacitors of the pixels on the sixth row are maintained at a constant L level. Thus, the storage capacitor SC of the corresponding capacitor line 12 maintains a data signal supplied from the data line DL via the selection transistor Tr1 as a potential difference with the capacitor signal SC7.

In a normal operation mode (and during inspection other than the predetermined defect inspection), on the other hand, because the selector terminal Tsc is connected to the GND (or is floating), the output from the capacitor signal fixing section 300 is set at the L level. Thus, the NOR circuit 240-7 outputs a capacitor signal SC7 which becomes the L level for a period in which the output G7-8 of the logical multiplication circuit 232-7 becomes the H level (the NOR circuit 240-7 functions similarly to an inversion circuit of the output of the logical multiplication circuit 232-7).

In the normal operation mode, the capacitor signal SC changes from the L level to the H level, to increase the gate potential of the element driving transistor Tr2 which is a p-channel type transistor and control the element driving transistor Tr2 to be switched off. The capacitor signal SC has the period of the L level (first voltage level Vsc1) which is equal to the H level period of the output from the logical multiplication circuit 232 and the remaining period within one vertical scan period is the period of the H level (second voltage level Vsc2), that is, a period of off-control of the element driving transistor Tr2 (period in which the EL element is extinguished). In other words, the non-emitting period of the EL element of each row corresponds to the L level period of the V start signal STV, and, thus, the non-emitting period can be adjusted by adjusting the L level period (pulse width) of the signal STV.

As shown in FIG. 4, the selection signal GL8 for the pixels of the next row is set to the H level during the horizontal scan period following the period in which the GL7 is set to the H level. If the device is in the defect inspection mode, the capacitor signal SC8 is fixed to the H level at all times similar to the capacitor signal SC7 for the sixth row. If, on the other hand, the device is in the normal operation mode, the capacitor signal SC8 for the next row is maintained at the L level for a period in which the logical multiplication output G8-9 is at the H level, is set to the H level at the timing when the logical multiplication output G8-9 is set to the L level, and the EL elements of the pixels of the eighth row are extinguished.

In this manner, capacitor signals (capacitor line control signals) that differ from each other by a horizontal scan period for every row and that is set to the H level to extinguish the EL elements for the same period are output to the capacitor lines 12 of each row, only when the selector terminal Tsc is set to the predetermined L level (GND or VVSS) or floating. The extinguish period (period of increased voltage of the capacitor signal) can be varied by the V start signal STV as described above and can be set, for example, at approximately 2 ms or may be further extended within a range that does not cause flicker in the light emission of the EL element. That is, the length can be extended to approximately 4 ms which is the longest time in which the extinguished element is recognized as a flicker by the human eye within a 16 ms period of one vertical scan period (one frame). When the capacitor signal is to be controlled by the external IC to be at the extinguishing level for all capacitor lines 12 during a vertical blanking period, the period that can be secured as the extinguishing period is approximately 900 μs. By generating the capacitor signal to be output to the capacitor line 12 using a built-in driver, it is possible to control the element driving transistor Tr2 and the EL element to be switched off in each pixel for each row, and, thus, the off-control period can be set for a long period of time and the persistent image can be reliably resolved.

As described above, with a structure of the V driver as shown in FIG. 2, the selection signal is obtained by a logic calculation of the form:
GLs=Gs−(s+1)AND XG(s+1)−(s+2)
In this equation, the term s represents a number of rows of pixels and is in the range of 1−n and the term XG represents an inverted signal of a corresponding G signal.

The capacitor signal in the normal operation mode can be obtained by inverting:
SCs=Gs−(s+1)
In the circuit structure of FIG. 2, voltages such as PVDD=8V, GND=0V, VVDD=10V, VVSS=−2V, CV=−2V, etc. can be prepared to set both the capacitor signal SC and the selection signal GL to be output to the capacitor line 12 and the gate line 10 to have the H level of VVDD and the L level of VVSS. By employing such a voltage relationship, switching on and off of the selection transistor Tr1 of each pixel, switching on and off of the element driving transistor Tr2, and the turning on and off of the EL element can be reliably and accurately controlled.

In FIG. 2, k stages of registers are provided, the number k being equal to the number of rows of pixels n plus 2 (k=n+2). Selection signals GL1 and GLk−1 and capacitor signals SC1 and SCk−1 are output to dummy pixels in a row before the pixels of the first row and dummy pixels in a row next to the pixels of the nth row. These dummy pixels do not need to be actually formed on the panel. The k stages of registers are provided because an sth output (output for pixel of (s−1)th row) is generated in the circuit structure of FIG. 2 using three stages of register outputs from (s−1) to (s+1) as described above.

### Second Preferred Embodiment

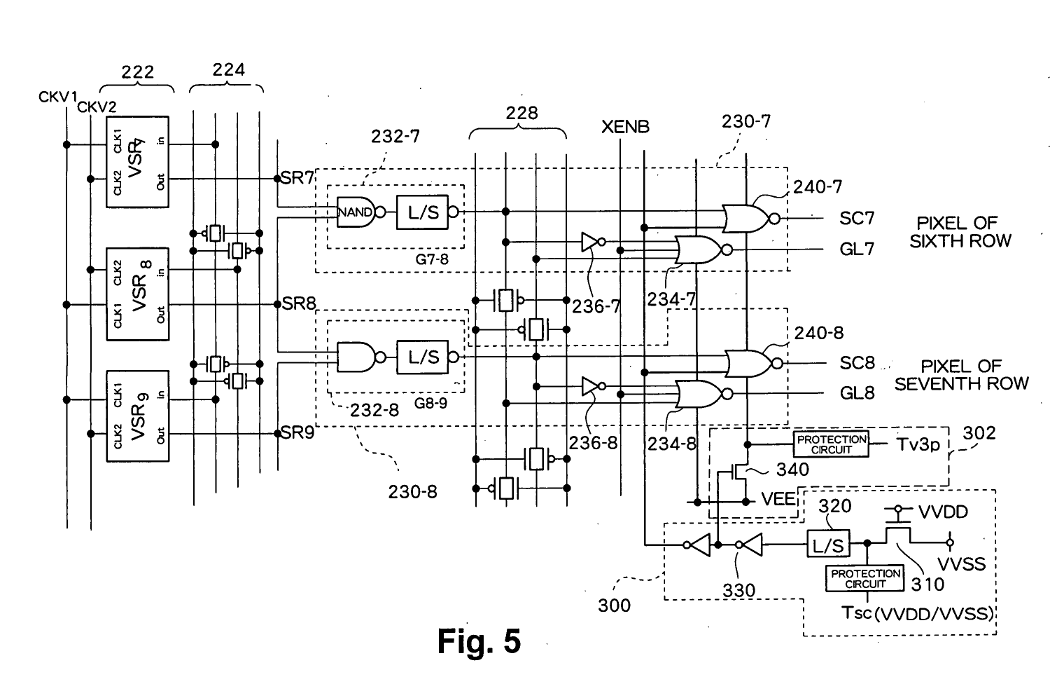

Next, another form of a structure for controlling a capacitor signal will be described as a second preferred embodiment of the present invention, referring to FIG. 5. A difference from the first preferred embodiment is that, in the second preferred embodiment, the power supply voltage of the capacitor signal outputting section which determines the output voltage of the capacitor signal can be set according to the mode, in addition to the capacitor signal fixing section 300. More specifically, the level can be set by providing a level setting section 302.

The level setting section 302 can be formed using a level setting terminal Tv3p. The level setting terminal Tv3p is connected to a low voltage power supply line of the capacitor signal outputting section (logic circuit 240) via a protection circuit. During a predetermined defect inspection, the power supply control terminal Tv3P can be connected to a power supply for setting an arbitrary level (external inspection power supply) V3P so that the inspection power supply V3P is supplied to the logic circuit 240 as the low voltage power supply. Similarly as in the first preferred embodiment, during the defect inspection, the capacitor signal fixing section 300 fixes the voltage level of the capacitor signal which is normally AC driven to one of the H level and the L level (in the exemplified configuration, L level) and the level setting section 302 controls the fixed voltage level of the capacitor signal to a level corresponding to the inspection power supply supplied to the power supply control terminal Tv3p.

The inspection power supply V3P can be set to an arbitrary voltage which allows precise detection, by the detection circuit, of a very small variation or the like of the capacitor in the pixel circuit and optimizes according to a number of pixel circuit elements and detection deficiency level. In general, for example, the inspection power supply V3P can be set to a potential identical to that of an input video signal or a potential identical to PVDD.

In the structure shown in FIG. 5, a switching element 340 is further provided, in addition to the power supply control terminal Tv3P, between a lower side power supply VEE which is common with circuits such as the H driver 210 and the V driver 220 built into the panel 110 and the power supply control terminal Tv3P. The switching element 340 is, for example, an n-channel thin film transistor (TFT) similar to the switching element 320 and can be formed simultaneously with the pixel circuit or the like. A gate electrode of the TFT 340 is connected to a signal line path from the selector terminal Tsc to the capacitor signal generator. More specifically, the gate electrode is connected to an inverter 330 provided at the output side of a level shifter 320 connected to the selector terminal Tsc via a protection circuit. In FIG. 5, the gate electrode is connected to an output of a first inverter of two inverters connected in series. One of a source and a drain of the switching element 340 is connected to a power supply VEE and the other one of the source and the drain is connected to a low voltage power supply line of the outputting section of the capacitor signal generator (a logic circuit comprising a NOR circuit 240 in the illustrated structure) and to the power supply control terminal Tv3p.

As described with reference to the first preferred embodiment, in a predetermined defect inspection mode, a power supply VVDD is connected to the selector terminal Tsc. Because of this, an L level voltage which is inverted by an inverter and which has an opposite polarity as VVDD with respect to a predetermined reference is applied to the gate of the switching element 340. As described above, because the switching element 340 is formed of an n-channel TFT, the switching element 340 is switched off when the L level voltage is applied to the gate electrode. In other words, the switching element 340 is switched off only when the device is in a predetermined defect inspection mode and a high level power supply VVDD is connected to the selector terminal Tsc. When the switching element 340 is switched off, the low voltage power supply line of the capacitor signal outputting section (logic circuit 240) is disconnected from the power supply VEE, to which the low voltage power supply line is connected during a normal operation mode via the switching element 340. In this process, the inspection power supply V3P supplied to the power supply control terminal Tv3p via a protection circuit is supplied as the lower side power supply of the logic circuit 240.

When the capacitor control line is to be AC driven, such as during a normal operation mode, the input voltage to the level shifter 320 is at the L level corresponding to VVSS or GND and a voltage applied to the gate of the switching element 340 is at the H level, and, thus, the switching element 340 is maintained at the ON state. Thus, it is possible to supply a power supply VEE as the lower side power supply of the logic circuit 240, similar to the lower side power supply of other logic circuits, via the switching element 340 during normal operation or the like, without generating a special switching signal.

During the defect inspection of the pixel circuit, a variation in the characteristic among the pixel circuits can be measured by detecting capacitance values of the pixels. For example, the selection transistor Tr1 shown in FIG. 1 is switched ON, inspection data is output to the data line 14, and the capacitance value is read by an external circuit via the data line 14. During this process, by setting the output of the logic circuit 240, that is, the voltage on the capacitor control line 12 to the inspection voltage V3P which is sufficiently low according to the characteristic of the inspection device, it is possible to charge the storage capacitor Cs of the pixel with a sufficient amount of charges. In particular, even when inspection data which has a sufficiently low level for switching the element driving transistor Tr2 which is a p-channel TFT ON is applied to the gate of the element driving transistor Tr2 via the selection transistor Tr1, the capacitor control line 12 can be maintained at a voltage sufficiently lower than the inspection data so that the inspection data can be accurately written to the storage capacitor Cs. In addition, because a sufficient amount of charges can be supplied to the storage capacitor Cs, it is possible to improve the precision, for example, of detection of the voltage corresponding to the amount of stored charges via the data line 14 as described above.

The voltage which can be set for the capacitor signal to be fixed can be arbitrarily set within a range which allows the capacitor signal outputting section to operate and which can be supplied as the inspection voltage V3P, and, thus, the freedom of setting of conditions for the defect inspection can be improved. In addition, by setting a plurality of voltages for the inspection voltages V3P and executing the inspection while changing the voltage, it is possible to set the measurement condition to a wide range, and influences due to parasitic capacitance associated with the structure of the pixel circuit can be reduced and a highly precise measurement of capacitance can be executed (as part of the defect inspection process).

Similarly as in the first preferred embodiment, in the second preferred embodiment also, the fixing control of the capacitor signal by the capacitor signal fixing section 300 is released and the capacitor line is AC driven during the normal operation and during inspection other than the predetermined inspection. The lower voltage (L level) of the output voltage levels in this case is the lower side power supply supplied to the capacitor signal outputting section at that point, which can be set to the voltage level of the low voltage power supply in other built-in circuits (VEE).

### Third Preferred Embodiment

A third preferred embodiment of the present invention will now be described. In the third preferred embodiment, a simpler circuit structure is provided for generating a selection signal GL and a capacitor signal SC similar to those in the first preferred embodiment based on outputs from registers of the vertical transfer register 222 and a structure for stopping the AC driving of the capacitor signal SC during the a predetermined inspection and for fixing the capacitor signal SC to an arbitrary set voltage similar to the second preferred embodiment is provided.

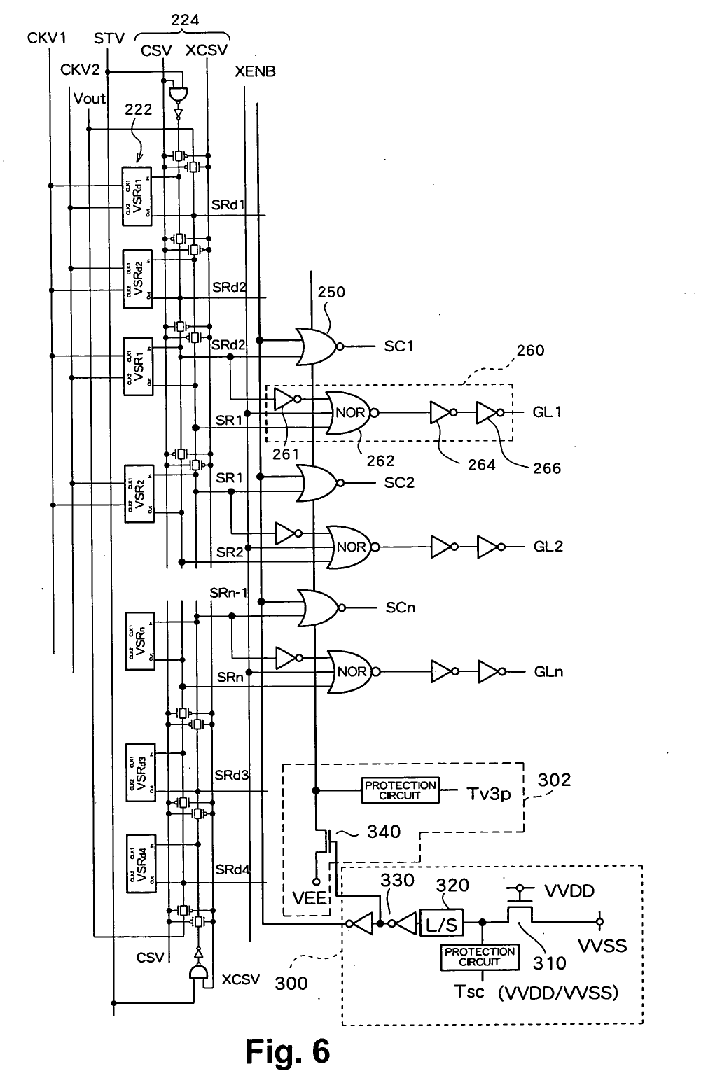

More specifically, the device of the third preferred embodiment has the following structure, as shown in FIG. 6. The structure corresponds to the structure of FIG. 2 in that the registers VSR of the vertical transfer register 222 transfer the input vertical start signal STV and the data input/output direction of the registers VSR is controlled by the transfer control gate 224, but differs from the structure of FIG. 2 in that the logic control gate 228 and the logical multiplication circuit 232 of FIG. 2 are omitted, the generator of the capacitor signal to be output to the capacitor line 12 is simplified to a structure with a NOR circuit 250 only (which functions as an inverter during normal operation), and the structure (logic) of the selection signal generator is different. In addition, although in the structure of FIG. 2, dummy pixels are provided at the uppermost row of the panel and at the lowermost row of the panel, and selection signal GL and the capacitor signal SC are generated and output to these rows also, in the structure of FIG. 6, two rows of dummy pixels are provided at the uppermost rows and at the lowermost rows. Because of this structure, dummy registers VSRd1 and VSRd2 are provided in front of the register VSR1 for the pixels of the first row.

In addition, in the third preferred embodiment, a non-inverted output from a previous register is supplied to one input terminal of the NOR circuit 250 forming the generator of the capacitor signal and a capacitor fix control signal from the capacitor signal fixing section 300 is supplied to the other input terminal of the NOR circuit 250. Similar to the first and second preferred embodiments, during a defect inspection mode of the pixel circuit or a persistent image inspection mode, a high voltage power supply such as VVDD is supplied to the control terminal Tsc and this power supply voltage is input to the NOR circuit 250 which is the logic circuit for controlling capacitor as the H level signal. Thus, in this case, the output from the NOR circuit 250 is fixed to the L level. The device further comprises the level setting section 302. In other words, a level setting terminal Tv3p which can be connected to the external power supply is provided and is connected to the lower side power supply of the NOR circuit 250 which is the capacitor signal outputting section. Therefore, when the output of the NOR circuit 250 is fixed such as in the persistent image inspection, the fixed L level of the output is controlled to a voltage level corresponding to the power supply voltage for inspection connected to the terminal Tv3p.

The overall circuit structure of FIG. 6 and operation of the circuit will now be described. When the transfer direction control signal CSV is at the H level, the V start signal STV is supplied to an input terminal in of the first dummy register VSRd1 and the register VSRd1 reads the V start signal STV at the rise of the vertical clock CKV1 and outputs from an output terminal out. An output SRd1 from the register VSRd1 is input to the second dummy register VSRd2 and the register VSRd2 reads the output SRd1 at the timing of the next fall of the signal CKV1 (timing of rise of CKV2) and outputs an output SRd2 from an output terminal out. The output SRd2 of the register VSRd2 is supplied to an input terminal in of the register VSR1 and the register VSR1 reads the output SRd2 at the timing of the next rise of the signal CKV1 and outputs an output SR1 from an output terminal out. The registers VSR1-VSRn are registers which output selection signals GL1-GLn and capacitor signals SC1-SCn to the actual pixels. Registers VSRd3 and VSRd4 corresponding to the dummy pixels are provided downstream of the register VSRn and these registers sequentially read the output of the register of the previous stage according to the rise or fall of the signal CKV1 and sequentially output to the register of the next stage.

As described above, the NOR circuit 250 is provided as the capacitor signal generator between an input line to the register VSRn of the nth stage and the capacitor line SCn of the nth row. An output signal of the register VSRn−1 is supplied to a first input of the NOR circuit 250 and a control signal from the capacitor signal fixing section 300 is supplied to a second input of the NOR circuit 250.

During a normal display operation, a control signal of L level is supplied from the capacitor signal fixing section 300 to the second input of the NOR circuit 250 according to the power supply VVSS or GND supplied to the terminal Tsc. Therefore, the NOR circuit 250 substantially functions as an inverter for inverting the output signal SRn−1 of the register VSRn−1 supplied to the first input of the NOR circuit 250 and an inverted signal of the register output signal SRn−1 is output to the corresponding capacitor line SCn from the NOR circuit 250 as the capacitor signal SCn for pixels of the nth row.

In the present embodiment, a voltage VVDD is supplied as the H level power supply to the NOR circuit 250 which corresponds to an outputting section for determining the voltage level of the capacitor signal. In addition, a power supply VEE is supplied during a normal operation as the L level power supply (low voltage power supply) via the switching element 340 and the inspection power supply V3P connected to the power supply control terminal Tv3p is supplied during the predetermined inspection as the L level power supply. Therefore, during a normal operation, the L level (first voltage level Vsc1) of the capacitor signal SC which is output from the NOR circuit 250 is set to a voltage level which is equal to VEE (for example, −2V) and the H level (second potential Vsc2) is set to a voltage which is equal to VVDD (for example, 10V). During the predetermined inspection, the capacitor signal SC is fixed to a predetermined voltage and the voltage value is set to the voltage V3P of the inspection power supply. It is preferable to use, as the voltage V3P, a value which is optimized in advance for the target circuit structure.

A selection signal generator 260 will now be described. In the present embodiment, the selection signal generator 260 is provided between the register VSRn (output thereof) and the selection line 10n, and is formed by a logic circuit.

The selection signal generator 260 comprises an inverter 261, a NOR circuit 262, and inverters 264 and 266. The output SRn of the register VSRn is supplied to a first input terminal of the NOR circuit 262, an inverted signal of an input signal to the register VSRn (XSRn−1) is supplied to a second input terminal via the inverter 261, and an inverted signal XENB of the enable signal is supplied to a third input terminal. The NOR circuit 262 thus calculates NOR of the register output SRn, XSRn−1, and inverted enable signal XENB. The inverter 264 inverts the output of the NOR circuit 262 and the inverter 266 further inverts the output of the inverter 264 and supplies the resulting signal to the selection line 10 for the pixels of the nth row. The NOR circuit 262 and the inverters 264 and 266 as a whole form a NOR gate which calculates NOR of the output SRn−1 and the output SRn and outputs a result of, the NOR calculation to the selection line 10 of the nth row as the selection signal GLn. As the inverter 264, the level shifter with an inversion function provided at the output side of the logical multiplication circuit 232 in FIG. 2 may be used so that the polarity of the output is inverted, the voltage level of the signal is shifted to a necessary voltage level, and the output of the level shifter is output to the inverter 266.

The input of the register VSR1 of the first row is the output SRd2 of the dummy register VSRd2 which is a previous register of the register VSR1. This output SRd2 is inverted by the inverter 250 (during the normal operation) and the inverted signal is output to the capacitor line 12 as the capacitor signal SC1 of the pixels of the first row. The selection signal generator 260 of the first row outputs a result of a NOR calculation between the inverted signal XSRd2 of the output SRd2 of the register VSRd2 and the output SR1 of the register VSR1 to the selection line 10 of the first row as the selection signal GL1.

As described, with the circuit structure of the V driver as shown in FIG. 6 also, the period corresponding to the L level period of the V start signal STV becomes the H level period of the capacitor signal SCn, that is, the extinguishing period of the EL element in the pixel of the corresponding row. Therefore, with the circuit structure of the third preferred embodiment also, the EL element can be extinguished and the element driving transistor Tr2 can be controlled to be switched off for each row by adjusting the V start signal STV. As described above, it is possible to omit the transfer gate and logic circuit compared to the circuit structure of FIG. 2, and, thus, the V driver 220 can be formed with a minimum number of circuit elements and the area of the V driver can be reduced. In a small display device which has severe demands for reduction of the circuit area on a panel such as, for example, an electric viewfinder (EVF) or the like, the area of the circuit elements to be built into the panel must be reduced. Therefore, the structure as described in the third preferred embodiment is advantageous for the display device such as EVF or the like. In addition, power consumption can be reduced with this structure.

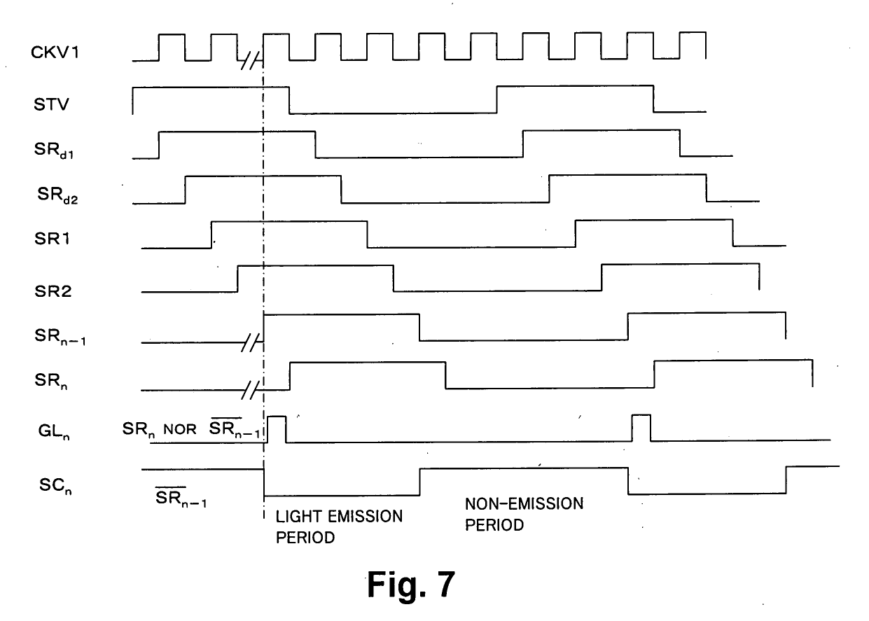

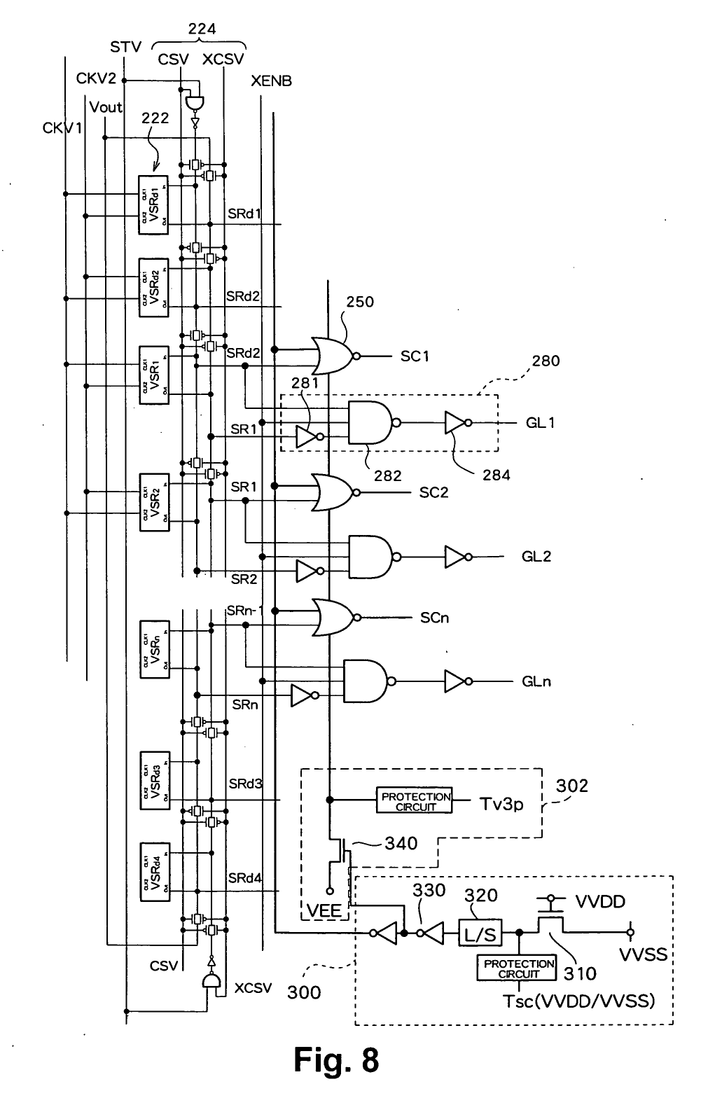

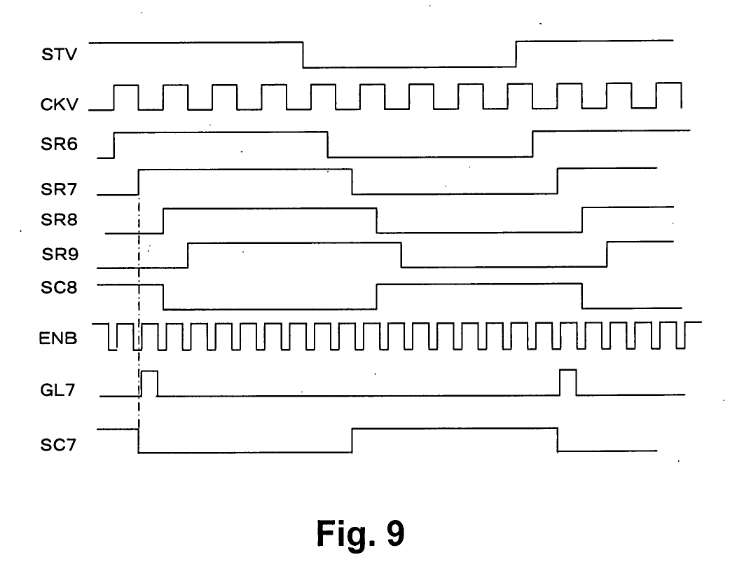

FIG. 8 shows a logic circuit structure in which the circuit structure specifically explained with reference to FIG. 6 is further generalized. FIG. 9 is a timing chart of the structure of FIG. 8. In the circuit structure of FIG. 8 also, a transfer control gate similar to the transfer control gate 224 of FIG. 2 is present, but is not shown in FIG. 8, as FIG. 8 exemplifies a configuration in which the transfer direction control signal CSV is at the H level and the data (V start signal STV) is transferred from the register VSRn−1 toward the register VSRn. The structures and operations of the capacitor signal generator (NOR circuit 250), the capacitor signal fixing section 300, and structures for controlling the level of the fixed capacitor signal are similar to those in FIGS. 6 and 7.

FIG. 8 shows registers VSR6-VSR8 and a signal generator which generates the selection signals GL7-GL9 and capacitor signals SC7-SC9 using the outputs of the registers VSR6-VSR8 as an intermediate stage of the V driver. The start signal STV is sequentially transferred to later registers according to the vertical clock CKV. When the output SR5 of the previous register VSR5 is input to the register VSR6, the register VSR6 reads the output SR5 according to the signal CKV and outputs a signal SR6. The output SR6 is supplied to the logical multiplication circuit 280 for the selection line of the seventh row and also to the first input of the NOR circuit 250. During a normal operation, an L level signal is supplied from the capacitor signal fixing section 300 to the second input of the NOR circuit 250. Thus, the NOR circuit 250 functions as an inverter for the output SR6 supplied to the first input and inverts the H and L levels of the output SR6, shifts the level of the output SR6 so that, for example, the H level is 10V (VVDD) and the L level is −2V (VEE), and outputs the resulting signal to the capacitor line for the pixels of the seventh row as the capacitor signal SC7.

A selection signal generator circuit (logical multiplication circuit for the selection signal) 280 of the seventh row comprises an inverter 281, a NAND circuit 282, and an inverter 284. The output SR6 of the register VSR6 is supplied to a first input of the NAND circuit 282, an inverted output XSR7 of the output SR7 of the shift register VSR7 of the next stage is supplied to the second input of the NAND circuit 282 via the inverter 281, and an enable signal is supplied to a third input of the NAND circuit 282. The NAND circuit 282 calculates NAND of these three inputs and the inverter 284 inverts the polarity of the calculated output. Therefore, a selection signal GL7, which is set to the H level when the output SR6 and the inverted output XSR7 are both at the H level and the enable signal ENB rises to allow the selection signal to the selection line, is output to the selection line for the pixels of the seventh row. In order to ensure that the level of the selection signal GL which is output from the logical multiplication circuit 280 can sufficiently drive the selection transistor of each pixel, a level shifter must be provided in a path from the register VSRn to the corresponding logical multiplication circuit 280 or within the circuit 280 to shift the H level and the L level of the register output SRn to 10V and −2V, respectively.

As described, with a structure of a logic circuit of FIG. 8, a capacitor signal SCn which is set to the H level for a period corresponding to the H level period of the V start signal STV can be output to the capacitor line of each row during a normal operation, similar to the specific circuit structure shown in FIG. 6. In addition, it is possible to output the selection signal to each selection line 10 every horizontal scan period and write a data signal corresponding to the display content to the corresponding pixel, and, at the same time, output the capacitor signal SC to the capacitor line 12 as described above and execute the control to extinguish the EL element and to switch the element driving transistor Tr2 off.

### Fourth Preferred Embodiment

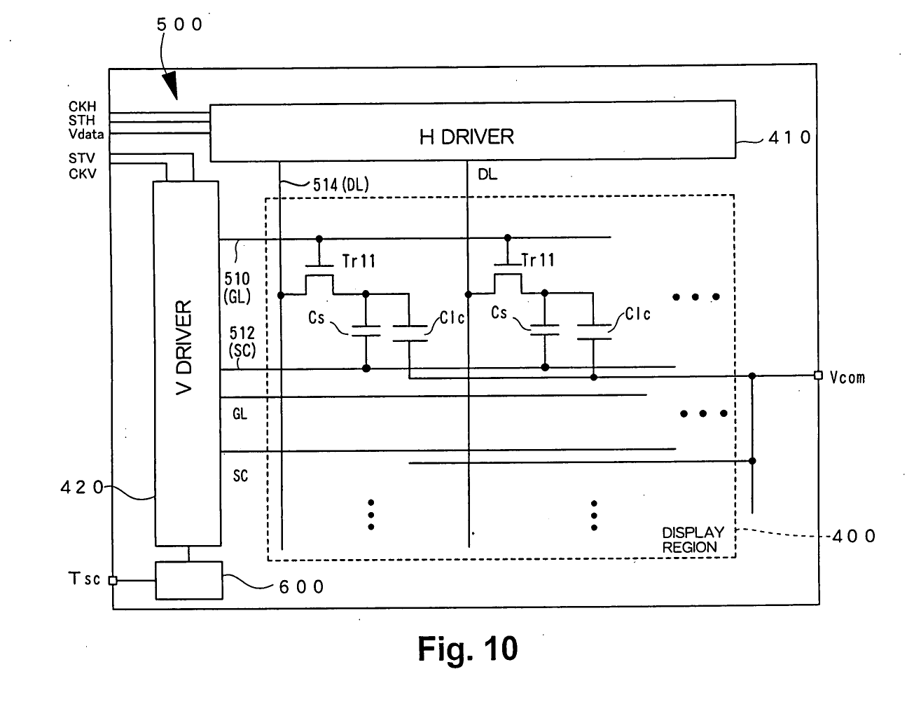

In the above-described preferred embodiments, control structures of the capacitor line in an EL display in which an EL element is used as a display pixel in each pixel have been described. The present invention, however, is not limited to these configurations and may alternatively be applied to a liquid crystal display device. Application of the present invention to a liquid crystal display device will now be described as the fourth preferred embodiment of the present invention, referring to FIG. 10.

When an EL element is used as the display element in each pixel, in particular, when an organic EL element is used, because the EL element is a current-driven element and has a diode structure, light emission and display are realized by applying a current corresponding to display data in one direction from the anode toward the cathode. In the first through third preferred embodiments described above, the capacitor line 512 is AC driven in order to periodically switch the element driving transistor Tr2 which is connected to the capacitor line 512 OFF via the storage capacitor Cs. During the defect inspection of the pixel, the AC signal output to the capacitor line 512 is stopped and the output voltage is maintained at a fixed voltage.

In a liquid crystal display device (hereinafter “LCD”) according to the fourth preferred embodiment, a voltage-driven liquid crystal element (Clc) is used as the display element. In the LCD, an AC driving of the liquid crystal is known in order to prevent persistent images on the liquid crystal. Among various LCDs, an active matrix LCD in which a highly precise control for each pixel can be applied comprises, in each pixel, a pixel transistor Tr11 for individually controlling the liquid crystal and a storage capacitor Cs connected in parallel with the liquid crystal element with respect to the transistor Tr11 and which stores a voltage to be applied to the liquid crystal for a predetermined period. When the liquid crystal is to be AC driven in the active matrix LCD in order to prevent persistent images, a method is known in which a capacitor signal output on a capacitor line 512 connected to the storage capacitor Cs of each pixel is periodically AC driven. When such a method is employed and the defect inspection of the pixels is executed, the capacitor signal which is output on the capacitor line 512 changes during the inspection and the capacitance value of the pixel cannot be accurately measured, similar to the above-described embodiments. Therefore, in order to achieve a highly precise defect inspection, it is desirable to allow selective fixing of the capacitor signal to a predetermined level during the inspection. In addition, when an H driver 410 and a V driver 420 for driving the pixel circuit are to be built in on the same substrate as the pixel TFT of a display portion 400, a structure must be incorporated which fixes the voltage level of the capacitor signal to be output to the capacitor line 512 during inspection.

For this purpose, in the fourth preferred embodiment, for example, a capacitor signal fixing section 600 having a structure similar to that in the first preferred embodiment is provided and a level setting section similar to that of FIG. 4 is provided on the substrate, although not shown in FIG. 10, in an active matrix LCD having a built-in driver so that the voltage level of the capacitor signal to be output on the capacitor line 512 can be fixed during the defect inspection of pixels.

This structure will now be described in detail. In an LCD, display is realized by controlling an alignment state of a liquid crystal layer sealed between a pair of substrates by a voltage applied between a first electrode and a second electrode respectively formed on each of the substrates on the side facing the liquid crystal. The alignment state of the liquid crystal layer is determined based on the absolute value of the applied voltage and regardless of the polarity of the applied voltage. Therefore, even when the polarity of the applied voltage is periodically inverted from the viewpoint of preventing persistent image of the display, the same display can be maintained when the absolute value is equal, and, thus, a polarity inversion driving, or AC driving, in which the polarity of the applied voltage to the liquid crystal layer is periodically inverted is used in LCDs. As an AC driving method of the liquid crystal, there are known a frame inversion driving method or a field inversion driving method in which the polarity of the voltage applied to the liquid crystal of each pixel is inverted every frame period or every field period, a line inversion driving method in which the polarity of the applied voltage is inverted for every line (every horizontal scan period), and a dot inversion driving method in which the polarity of the applied voltage is inverted for each pixel.

In the active matrix LCD, a pixel electrode having an individual pattern for each pixel is formed as a first electrode for driving the liquid crystal for each pixel on the side of the first substrate and a common electrode (opposing electrode) which is common to the pixels is formed on the side of the second substrate which is placed opposing the first substrate with the liquid crystal layer therebetween.

The pixel transistor Tr11 which is connected to the pixel electrode and the storage capacitor Cs are formed on the first substrate. In addition, a data line 514 for supplying a display data signal to these pixels, a selection line (gate line) 510 for selecting the pixel transistor Tr11, and a capacitor line 512 connected to one electrode of the storage capacitor Cs of each pixel (the other electrode of the storage capacitor Cs is connected to the pixel electrode) are formed on the first substrate.

In the present embodiment, the H driver 410 and the V driver 420 for controlling and driving the pixel circuit are formed at a peripheral region of the display portion 400 on the first substrate.

The pixel transistor Tr11 is formed of a TFT and an n-channel TFT is employed in this example structure as shown in FIG. 10. The built-in drivers (H driver 410 and V driver 420) are formed of TFTs which can be manufactured substantially through the same process as the pixel transistor Tr11. More specifically, an n-channel TFT and a p-channel TFT are used, and a number of circuit blocks are provided in a CMOS structure.

In an active matrix LCD, the polarity inversion driving of the liquid crystal performed in various periods as described above is basically executed by periodically inverting, at a predetermined period, the polarity of a display data signal supplied from the data line 514 to each pixel. In addition to the polarity inversion driving of the display data signal Vdata, inversion driving is applied so that one or both of a common electrode voltage and a capacitor electrode voltage (voltage on the capacitor line) has a polarity opposite to the polarity of the display data signal with respect to a reference. By AC driving one or both of the common electrode (Vcom) and the capacitor electrode (Vsc) in this manner, it is possible to reliably AC drive the liquid crystal capacity Clc of the pixel and reliably store charges corresponding to the display data in the storage capacitor Cs for a predetermined period while reducing the amplitude of the display data signal after the polarity inversion. The common electrode which has a large area and in which a conductive transparent metal oxide such as ITO (IndiumTin Oxide) and IZO (Indium Zinc Oxide) is used has a higher resistance compared to many metals such as Al, Cu, etc. which are used in many metal conductive layers. Therefore, when the polarity inversion period of-the voltage on the common electrode is shortened (when the frequency of AC driving is increased), the power consumption is increased. In consideration of this, it is also possible to AC drive only the display data signal and the capacitor signal, in order to further reduce the power consumption.

The fourth preferred embodiment can be applied to devices that AC drive the capacitor signal, regardless of whether or not the common electrode voltage is AC driven. When a display defect inspection is to be performed for completed LCDs before shipment from the factory, each pixel is selected, inspection data is written, and a change in the capacitance value in each pixel is read as a voltage signal from the data line or the like. Thus, if the voltage of the capacitor signal applied to the capacitor line changes during the inspection due to the AC driving, the electrode voltage of the storage capacitor Cs changes and the inspection precision would not be sufficient. Therefore, it is desirable to stop the AC driving of the capacitor signal and fix the capacitor signal voltage which is output to the capacitor line during the defect inspection. In particular, when a built-in driver is incorporated, the display portion can operate only according to the control by the built-in driver, and, therefore, the capacitor signal fixing section 600 must be formed on a TFT array substrate of the LCD on which the TFT is formed (here, the first substrate), as in the above-described embodiments.

The circuit structures of the H driver 410 and the V driver 420 of the LCD are basically equal in function to the corresponding drivers of the EL display as described above. More specifically, the H driver 410 outputs a display data signal Vdata corresponding to the display content of the corresponding pixel to the data line 514 provided for each column based on the horizontal start signal STH.

The V driver 420 generates a selection signal for selecting, for each row, pixels arranged in a matrix in the display portion 400 based on the vertical start signal STV, sequentially outputs the selection signal to selection lines (gate lines) 510 provided for each row, and outputs the capacitor signal Vsc to the capacitor line 512 connected to the storage capacitor Cs of each pixel.

The V driver 420 comprises, similar to the structures shown in FIGS. 2, 6, 8, etc., a V shift register (VSR) which sequentially transfers the vertical start signal STV and a signal generator which generates a selection signal based on the register output SR and which generates a capacitor signal. The waveform and output timing of the selection signal may be identical to, for example, the selection signal GL shown in FIGS. 4, 7, 9, etc., and a structure similar to those of FIGS. 2, 6, 8, etc. can be employed as the logic structure of the selection signal generator. Regarding the capacitor signal generator, on the other hand, a logic structure, for example, in which the inversion frequency is set to 1H (one horizontal scan period) is used when the polarity of the capacitor signal is to be inverted for each row.

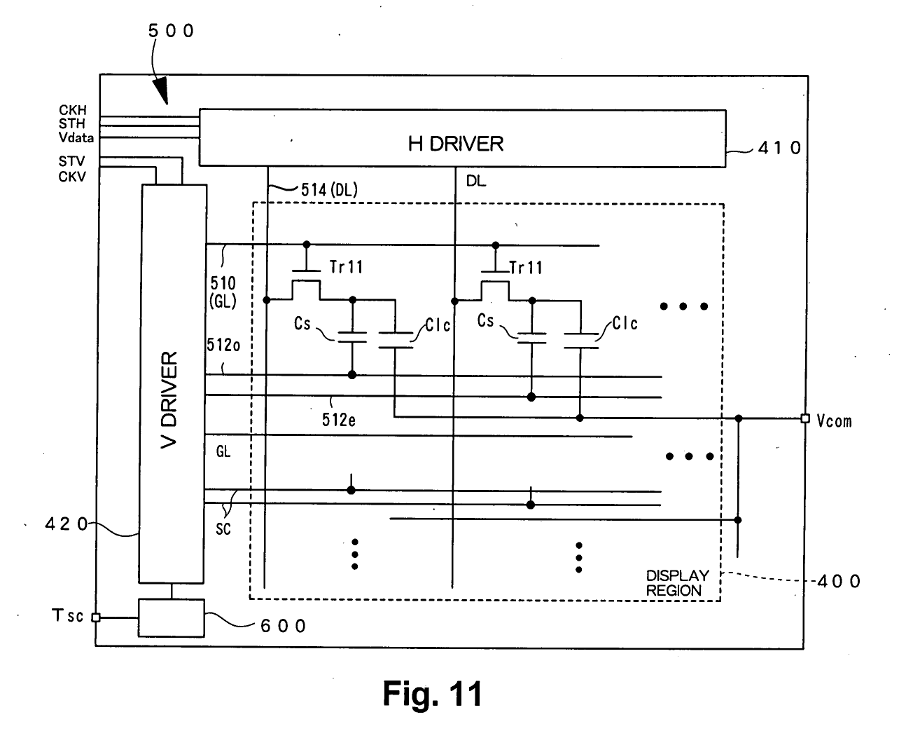

When the dot inversion driving method is employed in which the polarity is inverted for each pixel, it is effective to also set the capacitor signal to have different polarity for each pixel (for adjacent pixels along the row direction). On the other hand, during a period after the display data signal is written to the storage capacitor and before a new display data signal is next written, it is preferable that the storage capacitor electrode voltage is not changed from the viewpoint of minimizing the possibility of losing the stored data signal. Therefore, in the dot inversion method, two capacitor lines 512 are provided for each row as shown in FIG. 11, one of the capacitor lines (512o) is connected to the storage capacitor Cs of the pixels of an odd column, and the other capacitor line (512e) is connected to the storage capacitor Cs of the pixels of an even column to which a display data signal having an opposite polarity than that of the pixels of the odd column is supplied. The logic section of the capacitor signal generator of the V driver 420 generates capacitor signals in which the polarity inversion timings are set for each row, for the capacitor line for odd column and for the capacitor line for even column.

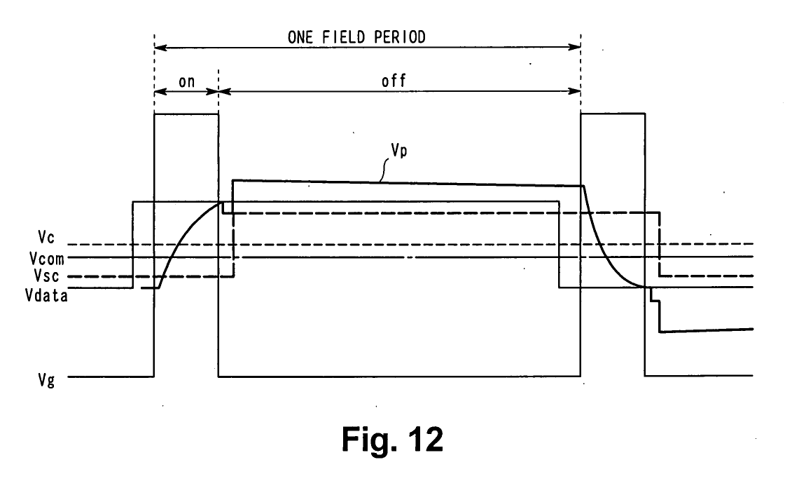

FIG. 12 shows example weveforms of signals when one of the pixels is considered in a normal display operation when the capacitor line is AC driven. The selection signal output to each row is set to a level (here, H level) which switches the pixel transistor Tr11 of the corresponding row ON for each horizontal scan period. In this process, in the example of FIG. 12, a display data signal Vdata having a polarity inverted for every field for each pixel is output to the corresponding data line 514.

When the selection signal is changed from the L level to the H level (selection level) and the pixel transistor Tr11 is switched ON, the display data signal is applied to the pixel electrode and to one of the electrodes of the storage capacitor through the drain and the source of the transistor Tr11. Then, when the selection signal falls from the H level to the L level, the pixel transistor Tr11 is switched OFF, charging to the storage capacitor Cs is stopped, and a voltage Vp applied to the pixel electrode is determined. The capacitor signal is maintained at a constant voltage until the pixel electrode voltage is determined, and, after the pixel electrode voltage is determined (after the transistor Tr11 is switched OFF), a polarity with respect to a reference voltage (here, a center voltage Vc) is inverted. In this example, when the polarity of the display data signal with respect to the center voltage Vc is at the H level, the capacitor signal Vsc changes from the L level to the H level after the transistor Tr11 is switched OFF. On the other hand, when the polarity of the data signal is L level, the capacitor signal Vsc changes from the H level to the L level after the transistor Tr11 is switched OFF. By changing the capacitor signal Vsc so that the capacitor signal Vsc has a polarity identical to that of the written display data signal, it is possible to shift the level of the display data voltage Vp stored in the storage capacitor Cs according to the change of the capacitor signal Vsc, as shown in FIG. 11. Therefore, it is possible to enlarge the display data voltage Vp to be applied to the liquid crystal capacity Clc in each pixel while minimizing the amplitude of the display data signal Vdata.

When the display defect is to be inspected in such a structure, if the pixels are driven in the normal manner, the level of the capacitor signal Vsc changes after the pixel transistor Tr11 is switched ON and the inspection data is written to the storage capacitor Cs. In other words, the pixel electrode voltage would significantly change during a process of reading the written inspection data via the data line, resulting in degradation of inspection precision. Therefore, it is preferable, during the inspection, to stop the level change (AC driving) of the capacitor signal and set the pixel electrode voltage via the capacitor line 512 to a voltage which allows improvement in the inspection precision.

When the capacitor line is AC driven as described above, the capacitor signal generator can generate the capacitor signal having a waveform as shown in FIG. 11 by applying a logic calculation to an output from the V shift register or the like. The capacitor signal may be generated by simply inverting a predetermined register output in some cases. In consideration of this, in the present embodiment also, a logic circuit is provided at the output stage of the capacitor signal, a capacitor signal fixing section 600 having a structure similar to that of FIG. 2, etc. is provided, and a capacitor fix control signal for fixing an output level of an output circuit of the capacitor signal (logic circuit 240 of FIG. 2, etc.) as necessary is supplied to the output circuit of the capacitor signal. With this structure, the AC output of the capacitor signal is not limited during the normal display mode of the display, and, when defect inspection of the display panel is performed such as when the display is shipped from the factory, the voltage level of the capacitor signal can be fixed to the predetermined level. The structure is not limited to a structure to input the capacitor fix control signal to the input of the final logic circuit, and it is also possible to employ a structure in which a TFT dedicated to switching the output voltage is separately formed on the substrate simultaneously with the driver, the TFT is connected to the capacitor line 512, the TFT is operated as necessary such as during inspection, and the voltage level of the capacitor signal is connected to a power supply of a constant voltage.

By providing a level setting section having a structure similar to that in FIG. 2, the voltage level of the capacitor signal when the capacitor signal is fixed can be set at an arbitrary level by the power supply V3P connected to the setting terminal Tv3p.

In the above-described embodiments, the fix control terminal Tsc and the level setting terminal Tv3p are connected to the corresponding circuits of the capacitor signal generator via protection circuits primarily in order to prevent electrostatic breakdown of the circuits on the panel due to intrusion of electrostatic noise or the like through these terminals.

What is claimed is:

1. A display device comprising a display region having a plurality of pixels arranged in a matrix form and a driver circuit which drives the plurality of pixels in the display region, wherein
in the display region, each of the plurality of pixels comprises a display element, a pixel transistor which controls the display element according to display data, and a storage capacitor which stores the display data for a predetermined period;
the storage capacitor comprises a first electrode and a second electrode, the first electrode being connected between the pixel transistor and the display element and the second electrode being connected to a capacitor line;
the driver circuit comprises at least a vertical direction driver and a capacitor signal fixing section;
the vertical direction driver comprises a capacitor signal generator which outputs a predetermined alternate current signal to the capacitor line as a capacitor signal, and
the capacitor signal fixing section selectively fixes the capacitor signal which is output from the capacitor signal generator to a direct current level.

2. A display device according to claim 1, further comprising:
a level setting section which sets the voltage level of the capacitor signal which is output from the capacitor signal generator.

3. A display device according to claim 2, wherein
when the level setting section detects that a fix control signal is being output from the capacitor signal fixing section, the level setting section sets a level of an output section power supply voltage which determines a voltage value of the capacitor signal at a capacitor signal outputting section of the capacitor signal generator.

4. A display device according to claim 2, wherein
the level setting section comprises a level setting terminal and the voltage level of the capacitor signal is set according to a setting power supply connected to the level setting terminal.

5. A display device according to claim 1, wherein
the capacitor signal fixing section comprises a fix control terminal and controls fixing of the capacitor signal to the direct current level according to a power supply voltage connected to the fix control terminal.

6. A display device according to claim 1, wherein
the capacitor signal fixing section fixes a level of the capacitor signal during an operation inspection mode in the display region.

7. A display device comprising a display region having a plurality of pixels arranged in a matrix form and a driver circuit which drives the plurality of pixels in the display region, wherein
in the display region, each of the plurality of pixels comprises a display element, a pixel transistor which controls the display element according to display data, and a storage capacitor which stores the display data for a predetermined period;
the storage capacitor comprises a first electrode and a second electrode, the first electrode being connected between the pixel transistor and the display element and the second electrode being connected to a capacitor line;
a selection line for selecting a pixel transistor of a corresponding pixel and a capacitor line for controlling a potential on the second electrode of the storage capacitor are formed extending along a horizontal scan direction of the display region;
the driver circuit comprises at least a vertical direction driver and a capacitor signal fixing section;
the vertical direction driver generates, based on a vertical start signal indicating a start timing of a vertical scan period, a selection signal which is sequentially output to the selection line for selecting the pixel transistors of a corresponding row and generates a capacitor signal in which a first voltage level period and a second voltage level period are set in a horizontal scan period based on the vertical start signal and which is sequentially output to the capacitor line, and
the capacitor signal fixing section selectively fixes the capacitor signal which is output from the vertical direction driver to a direct current level.

8. A display device according to claim 7, wherein
the vertical direction driver comprises:
a vertical transfer register having a plurality of stages of registers which read and sequentially transfer the vertical start signal;
a selection signal generator which generates the selection signal to be supplied to the selection line based on an output of the vertical transfer register; and
a capacitor signal generator which generates the capacitor signal based on the output of the vertical transfer register.

9. A display device according to claim 8, wherein
the capacitor signal generator comprises a logic circuit which outputs the capacitor signal to the capacitor line, and
a fix control signal of a predetermined level from the capacitor signal fixing section is supplied to one input terminal of the logic circuit and an output level of the capacitor signal from the logic circuit is fixed according to the fix control signal.

10. A display device according to claim 7, further comprising
a level setting section which sets the voltage level of the capacitor signal which is output from the capacitor signal generator.

11. A display device according to claim 10, wherein
when the level setting section detects that a fix control signal is being output from the capacitor signal fixing section, the level setting section sets a level of an output section power supply voltage which determines a voltage value of the capacitor signal at a capacitor signal outputting section of the capacitor signal generator.

12. A display device according to claim 10, wherein
the level setting section comprises a level setting terminal and the voltage level of the capacitor signal is set according to a setting power supply connected to the level setting terminal.

13. A display device according to claim 7, wherein
the capacitor signal fixing section comprises a fix control terminal and controls fixing of the capacitor signal to the direct current level according to a power supply voltage connected to the fix control terminal.

14. A display device according to claim 7, wherein
the capacitor signal fixing section fixes a level of the capacitor signal during an operation inspection mode in the display region.
